(19) United States
(12) Patent Application Publication
(10) Pub. No.: US 2020/0225617 A1
(43) Pub. Date: Jul. 16, 2020

(54) Artistic Butterfly Wall Clock

(71) Applicant: Cassandra Bohne-Linnard, Cypress, TX (US)

(72) Inventor: Cassandra Bohne-Linnard, Cypress, TX (US)

(21) Appl. No.: 16/832,617

(22) Filed: Mar. 27, 2020

(51) Int. Cl. G04B 45/00; G04B 37/00

(52) U.S. Cl. CPC G04B 45/0069; G04B 37/0066

(57) ABSTRACT

An artistic butterfly wall clock made with real preserved butterfly specimens as indicators and other artistic design within a glass fronted shadow box preserving the delicate features of the real butterfly specimens.

### CROSS-REFERENCE TO RELATED APPLICATIONS

Not Applicable.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISC APPENDIX

Not Applicable.

### BACKGROUND OF THE INVENTION

### Field of the Invention

This invention relates generally to horology. More particularly, the invention relates to an artistic design for a dial of a wall clock.

### BRIEF DESCRIPTION OF THE DRAWINGS

FIG. 1 is a front view of a dial for a wall clock, sans hands and case in accordance with an embodiment of the innovation.

FIG. 2 is a front view of a wall clock in accordance with an embodiment of the innovation.

### DETAILED DESCRIPTION OF THE PREFERRED EMBODIMENTS

The innovation comprises preserved real butterflies mounted to wall décor to create artistic art in the form of a dial for a wall clock. The wall clock further comprises common clockworks for electromechanical operation. The wall décor of the preferred embodiment is a decorative medallion mounted within a rectangular glass fronted shadowbox to protect the butterflies that are by their nature very fragile.

One skilled in the art would appreciate variations which are encompassed within the teachings. One embodiment uses a rounded shadowbox. Another embodiment uses rectangular wall décor. Another embodiment uses the rear panel of the shadowbox as the wall décor component.

Any of the wall décor described may be textured and/or carved. The wall décor may optionally be painted with one or more colors and/or patters to enhance/complement the butterflies selected for a particular embodiment. The shadowbox should be of sufficient depth to receive the wall décor with the butterflies and allow clear operation of the clock's hands behind the protective glass front.

The butterflies may be positioned at the four cardinal positions (those typically indicating 3, 6, 9, and 12). In one embodiment each position uses the same specimen of butterfly. In another embodiment each position has a different specimen. The butterflies at each position may be oriented horizontally, vertically, radially, or they may each be randomly oriented.

In one embodiment intercardinal positions may be unmarked. In another embodiment the intercardinal positions may be marked by additional butterflies. These additional butterflies may be identical to those used in the cardinal markings; of a single different specimen, or of varying specimens.

The cardinal and intercardinal positions may be marked with specimens of differing sizes. The hands and clock works are not claimed as unique. The components of each device are utilized in a unique individual combination to create an artistic expression so each embodiment may also be a unique instantiation.

### DETAILED DESCRIPTION OF THE DRAWINGS

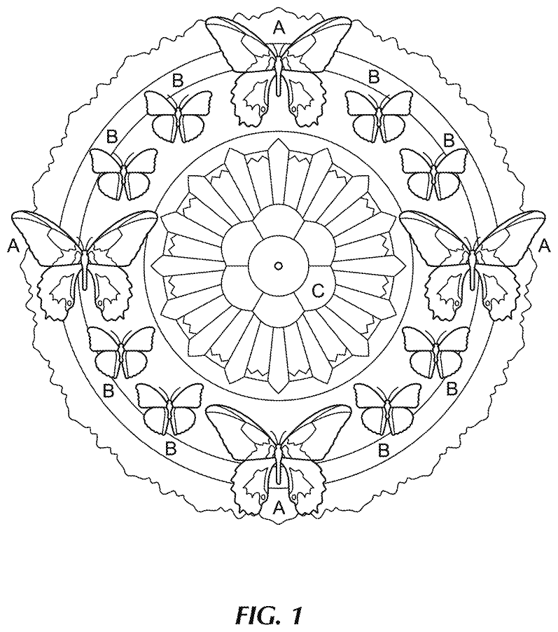

FIG. 1 is a front view of a dial for a wall clock, sans hands and case in accordance with an embodiment of the innovation. The dial of the wall clock is comprised of a decorative medallion (C) as a center and/or background for preserved butterflies in place of the numeral indicators found on usual dials. The four cardinal positions are marked by mounted butterfly specimens (A).

The intercardinal positions are optionally marked by additional butterfly specimens (B) shown here as a different specimen from those of cardinal markings. The orientation of each butterfly may be varied from that indicated in the drawing.

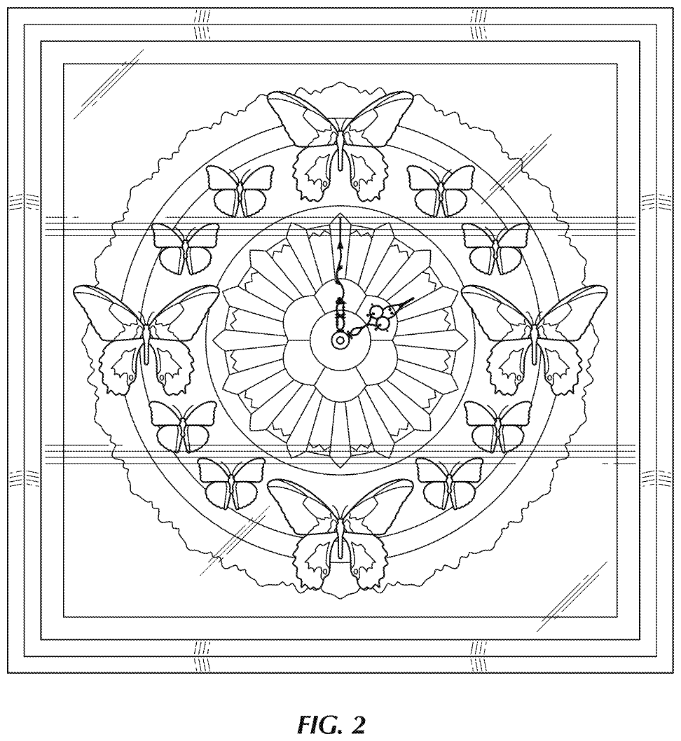

FIG. 2 is a front view of a wall clock in accordance with an embodiment of the innovation. The dial of FIG. 1 is fitted with clock works and mounted within a glass faced shadowbox having sufficient depth to enclose and protect the delicate decorative dial of the clock.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A wall clock comprising:
a clock face,
a clockwork mechanism positioning a minute hand, hour hand, and optional second hand for indicating a current time;
mounted within a glass fronted shadow box;
the clock face comprising:
a decorative medallion, and
real preserved butterfly specimens.

2. The wall clock of claim 1 wherein the butterfly specimens are located at the cardinal positions.

3. The wall clock of claim 1 wherein the butterfly specimens are located at the intercardinal positions.

4. The wall clock of claim 1 wherein all butterfly specimens substantially similar specimens.

5. The wall clock of claim 1 wherein the medallion is painted.

6. The wall clock of claim 1 wherein the medallion is textured.
